(19) United States
(12) Patent Application Publication
(10) Pub. No.: US 2026/0277985 A1
(43) Pub. Date: Sep. 17, 2026

(54) MACHINE LEARNING SYSTEM WITH ONTOLOGY SCHEMAS AND INTENT SCHEMAS

(71) Applicant: Microsoft Technology Licensing, LLC, Redmond, WA (US)

(72) Inventors: Hillary Mucheru MUTISYA, Seattle, WA (US); Steven Edward LUCCO, Bellevue, WA (US)

(73) Assignee: Microsoft Technology Licensing, LLC, Redmond, WA (US)

(21) Appl. No.: 19/080,618

(22) Filed: Mar. 14, 2025

(51) Int. Cl. G06F 16/36; G06F 16/334; G06F 40/20

(52) U.S. Cl. CPC G06F 16/367; G06F 16/3347; G06F 40/20

(57) ABSTRACT

A computing system including one or more processing devices configured to execute a machine learning (ML) assistant interface. The processing devices receive a user input that specifies an interaction with an application interface. The processing devices receive application interface code of the application interface, and based on the application interface code, select an ontology schema from a plurality of ontology schemas. Based on the user input and the ontology schema, the processing devices select an intent schema from a plurality of intent schemas. The processing devices populate the ontology schema with interactable elements of the application interface identified in the application interface code, and, based on the populated ontology schema and the user input, populate the intent schema with one or more interface element interactions. At the application interface, the processing devices perform the interface element interactions at an interactable element specified in the populated ontology schema.

### BACKGROUND

As the language modeling capabilities of generative language models have advanced, those generative language models have been incorporated into a wide variety of computing workflows that use generative language models to control other computing processes. For example, generative language models have been used in machine learning (ML) agent systems to convert user instructions into computer code that is subsequently compiled and executed at a computing system. The code may perform a user-specified action at another application program. Accordingly, the generative language model is used as a component of a processing pipeline that interprets and follows a user's semantically specified instructions.

### SUMMARY

According to one aspect of the present disclosure, a computing system is provided, including one or more processing devices configured to execute a machine learning (ML) assistant interface over which a plurality of conversational turns are exchanged between a user and an ML system that includes a generative language model. At the ML system, the one or more processing devices are further configured to, via the ML assistant interface, receive a user input that specifies an interaction with an application interface of an application program. The one or more processing devices are further configured to receive application interface code of the application interface. Based at least in part on the application interface code, the one or more processing devices are further configured to select an ontology schema from among a plurality of ontology schemas. Based at least in part on the user input and the ontology schema, the one or more processing devices are further configured to select an intent schema from among a plurality of intent schemas. The one or more processing devices are further configured to populate the ontology schema with a plurality of interactable elements of the application interface identified in the application interface code. Based at least in part on the populated ontology schema and the user input, the one or more processing devices are further configured to populate the intent schema with one or more interface element interactions. At the application interface, the one or more processing devices are further configured to programmatically perform the one or more interface element interactions specified by the populated intent schema at an interactable element of the plurality of interactable elements specified in the populated ontology schema.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example computing system at which one or more processing devices are configured to execute a user interface, an application program, and a machine learning (ML) system, according to one example embodiment.

FIG. 2 schematically shows an example user interface including an ML assistant interface and an application interface of a weather application program, according to the example of FIG. 1.

FIG. 3 schematically shows the computing system when, via the ML assistant interface, the one or more processing devices receive a user input that specifies an interaction with the application interface, according to the example of FIG. 1.

FIG. 4A schematically shows the computing system in an example in which vector similarity matching is performed to select an ontology schema, according to the example of FIG. 1.

FIG. 4B schematically shows the computing system in an example in which vector similarity matching is performed to select an intent schema, according to the example of FIG. 1.

FIG. 5 schematically shows the computing system in an example in which the one or more processing devices are further configured to execute a dispatcher included in the ML system, according to the example of FIG. 1.

FIG. 6 schematically shows the computing system subsequently to the selection of the ontology schema and the intent schema, according to the example of FIG. 1.

FIG. 7 schematically shows the computing system in an example in which the one or more processing devices are configured to programmatically perform ontology schema discovery and intent schema discovery, according to the example of FIG. 1.

FIG. 8A shows a flowchart of a method for use with a computing system to programmatically interact with an application interface as indicated by user input to an ML system, according to the example of FIG. 1.

FIGS. 8B-8D show additional steps of the method of FIG. 8A that may be performed in some examples.

FIG. 9 shows a schematic view of an example computing environment in which the computing system of FIG. 1 may be instantiated.

### DETAILED DESCRIPTION

When using an ML agent system, a user may provide semantically specified instructions for the ML agent system to perform an action at an application program. For example, the user may instruct the ML system to perform a specified action at a webpage displayed in a web browser. However, webpages and other application interfaces vary widely in their layouts and in the types of eligible actions they present to the user. Existing ML agent systems often have too little flexibility to perform user-specified actions at many application programs and webpages. The developer of an ML agent system may have to explicitly code the user interface properties of a specific application program or webpage, such as the locations of interactable elements and the events that occur when a user or ML agent system interacts with those interactable elements. Explicitly defining interface properties in this manner scales poorly to large numbers of different interface configurations. In addition, the developer of the ML agent system may have to rewrite portions of the user interface property specification whenever the interface of the application program or webpage is modified.

Existing ML agent systems may also encounter difficulties in translating user instructions into the specific interactions that are performed at the interface of the application program or webpage. The user may specify the intended action in many different ways, such as with different phrasing or even in different languages. To perform the specified action, the ML agent system has to map the user's instructions onto one or more interactions performed at the interactable elements of the user interface. The ML agent system may therefore be inconsistent in converting the user input into computer-executable instructions. Accurately carrying out the user's instructions may be especially difficult for existing ML agent systems in examples in which the ML agent system performs a multi-stage interaction sequence at the interface, including transitions between multiple different user interface views or webpages.

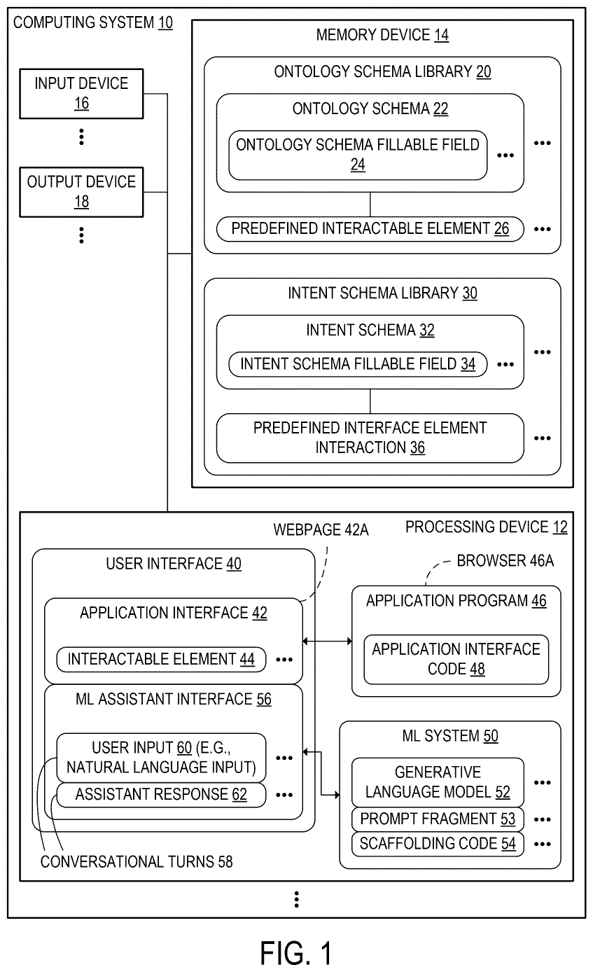

In order to address the above shortcomings, a computing system 10 is provided, as schematically depicted in the example of FIG. 1. The computing system 10 includes one or more processing devices 12 and one or more memory devices 14. The one or more processing devices 12 may, for example, include one or more central processing units (CPUs), graphics processing units (GPUs), neural processing units (NPUs), and/or other types of hardware accelerators. The one or more memory devices 14 may, for example, include one or more volatile memory devices and one or more non-volatile storage devices. The computing system 10 further includes one or more input devices 16 and one or more output devices 18.

In some examples, the one or more processing devices 12, the one or more memory devices 14, the one or more input devices 16, and the one or more output devices 18 may be distributed among a plurality of different physical computing devices. For example, the physical computing devices included in the computing system 10 may have a server-client configuration. In other examples, the computing system 10 may be implemented at a single physical computing device.

The one or more processing devices 12 are configured to execute a user interface 40. At the user interface 40, a user interacts with the computing system 10 via the one or more input devices 16 and the one or more output devices 18. For example, the user interface 40 may be a graphical user interface (GUI) presented to the user at one or more display devices included among the one or more output devices 18. In other examples, the user interface 40 may be an audio interface.

The user interface 40 includes an application interface 42 of an application program 46. In some examples, the application interface 42 is a webpage 42A presented to the user at a browser 46A. In other examples, the application interface 42 may be the interface of some other type of application program 46. The application interface 42 includes a plurality of interactable elements 44 that are configured to be selectable by the user. In examples in which the user interface 40 is a GUI, the interactable elements 44 may be interactable GUI elements. The application program 46 includes application interface code 48 that the one or more processing devices 12 are configured to execute in order to construct the application interface 42.

The user interface 40 includes an ML assistant interface 56 over which a plurality of conversational turns 58 are exchanged between the user and an ML system 50. The plurality of conversational turns 58 include one or more user inputs 60 and one or more assistant responses 62. For example, the user input 60 may be natural language input. The one or more assistant responses 62 may include one or more natural language outputs. As discussed in further detail below, the one or more assistant responses 62 further include one or more interactions with the application interface 42.

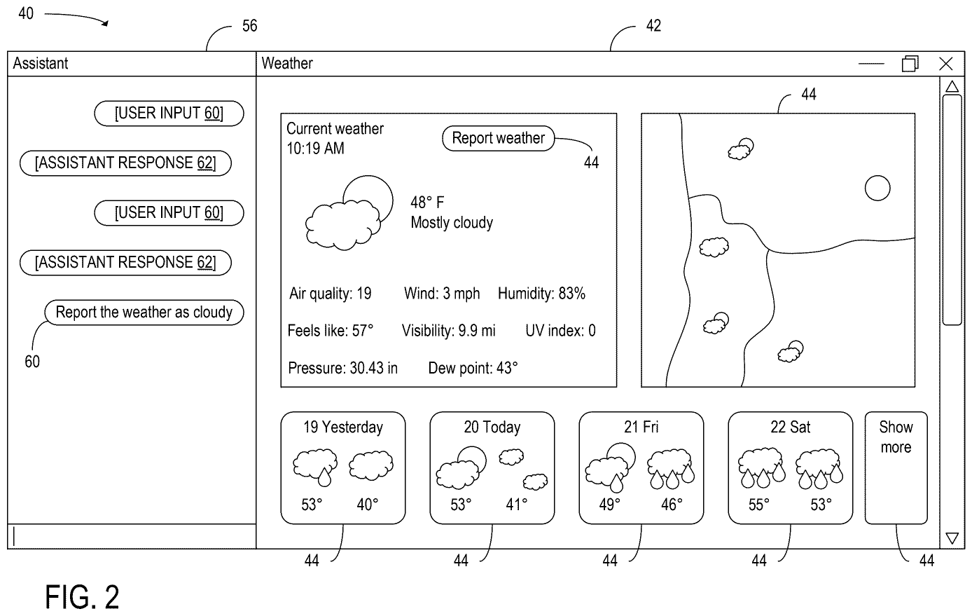

FIG. 2 schematically shows an example user interface 40 including an application interface 42 and an ML assistant interface 56. The application interface 42 shown in FIG. 2 is a GUI of a weather application program. The application interface 42 includes a plurality of interactable elements, which may be selected to perform actions at the GUI such as viewing a more detailed map, viewing more detailed information about the weather on specific days, showing forecasts for more days, and entering a report of the user's local weather. At the ML assistant interface 56 shown in the example of FIG. 2, the user and the ML system 50 exchange respective conversational turns 58 including a plurality of user inputs 60 and assistant responses 62. FIG. 2 shows the user interface 40 when the user has entered the input “Report the weather as cloudy.”

Returning to the example of FIG. 1, the ML system 50 includes a generative language model 52 at which the one or more assistant responses 62 are generated. This generative language model 52 may be a large language model (LLM), a small language model (SLM), or a large multimodal model (LMM). In some examples, the ML system 50 includes a plurality of different generative language models 52.

The ML system 50 may further include a plurality of prompt fragments 53 that the one or more processing devices 12 are configured to load into the context windows the of the one or more generative language models 52. Using these prompt fragments 53, along with the conversational turns 58 exchanged at the ML assistant interface 56, the one or more processing devices 12 are configured to guide the generation of the assistant responses 62 at the one or more generative language models 52.

The ML system 50 may further include a plurality of sets of scaffolding code 54 associated with the one or more generative language models 52. The scaffolding code 54 specifies computing processes within which the one or more generative language models 52 are executed. For example, the scaffolding code 54 may specify conditions under which the one or more processing devices 12 are configured to perform inferencing at the one or more generative language models 52. The scaffolding code 54 may also include one or more pre-processing operations, such as operations by which the prompt fragments 53 are selected, and/or post-processing operations, such as operations that convert an output of a generative language model 52 into a format that is displayable at the ML assistant interface 56.

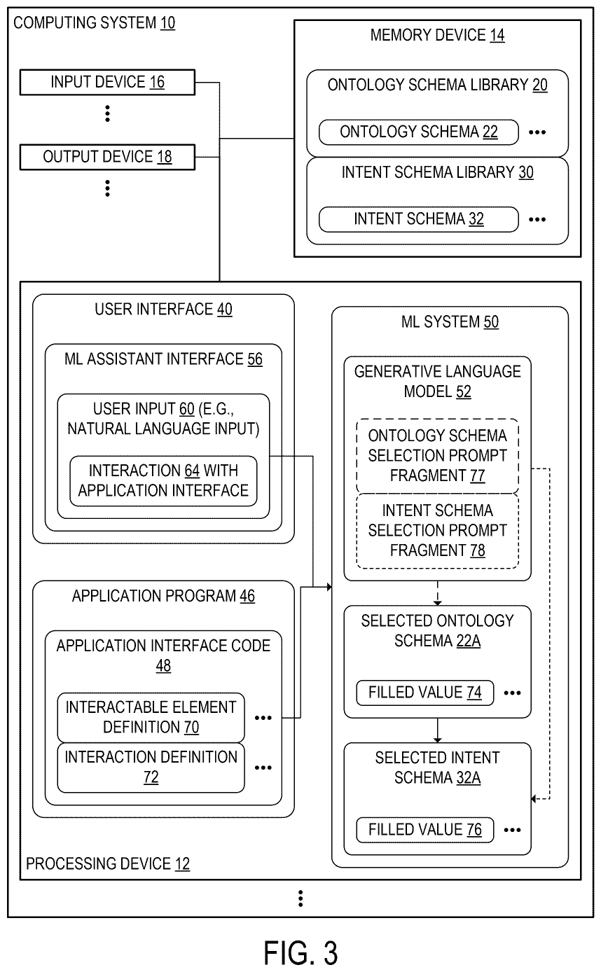

FIG. 3 schematically shows the computing system 10 when, via the ML assistant interface 56, the one or more processing devices 12 are configured to receive a user input 60 that specifies an interaction 64 with the application interface 42. For example, the interaction 64 specified in the example of FIG. 2 is reporting the user's local weather as cloudy. As another example, the user input 60 may instruct the ML system 50 to purchase a specified item at an e-commerce website. As another example, the user input 60 may instruct the ML system 50 to retrieve a clue or enter a word at a crossword website.

In addition to receiving the user input 60, the ML system 50 is configured to receive the application interface code 48 of the application interface 42. The application interface code 48 includes respective interactable element definitions 70 of the plurality of interactable elements 44 included in the application interface 42. For example, the interactable element definitions 70 may specify the respective sizes, locations, and other visual characteristics of interactable GUI elements. In addition, the application interface code 48 includes respective interaction definitions 72 of eligible interactions with the interactable elements 44 that may be performed at the application interface 42.

As shown in the example of FIG. 1, the one or more memory devices 14 store an ontology schema library 20 including a plurality of ontology schemas 22 associated with respective application interface types. In this example, each of the ontology schemas 22 includes a plurality of ontology schema fillable fields 24. The ontology schema library 20 further includes a respective plurality of predefined interactable elements 26 associated with each of the ontology schemas 22. The predefined interactable elements 26 are types of interactable elements 44 that may occur at an application interface 42 of the application interface type associated with the ontology schema 22.

In one example, an ontology schema 22 associated with weather application interfaces may include definitions of a “current weather details” interactable element, a “day details” interactable element, a “report weather button” interactable element, and a “map” interactable element. Other types of interactable elements 44 may also be defined in the ontology schema 22 of the weather application interface type in some examples.

As another example, an ontology schema 22 associated with crossword website interfaces may include definitions of a “letter field” interactable element, a “clue” interactable element, and a “hint” interactable element, as well as potentially other types of interactable elements that may be included in crossword website interfaces.

In the example of FIG. 1, the one or more memory devices 14 further store an intent schema library 30 including a plurality of intent schemas 32. Each of the intent schemas 32 includes one or more intent schema fillable fields 34. In addition, the intent schema library 30 includes a plurality of predefined interface element interactions 36. These predefined interface element interactions 36 are eligible types of interactions with the interactable elements 44 of the application interface 42.

As one example, an e-commerce intent schema may include a “search” interaction, a “get product details” interaction, a “leave review” interaction, an “add to cart” interaction, a “remove from cart” interaction, and a “checkout” interaction. Other predefined interface element interactions 36 may also be included in the intent schema 32.

The intent schemas 32 stored in the intent schema library 30 may be linked to corresponding ontology schemas 22, such that the intent schemas 32 indicate the available interactions that may be performed at the types of application interfaces 42 associated with the ontology schemas 22. In some examples, an ontology schema 22 may have a plurality of corresponding intent schemas 32 that may be selected when the ontology schema 22 is used, as discussed in further detail below.

Returning to the example of FIG. 3, based at least in part on the application interface code 48, the one or more processing devices 12 are further configured to select an ontology schema 22A from among the plurality of ontology schemas 22 stored in the ontology schema library 20. In some examples, the one or more processing devices 12 may be configured to select the ontology schema 22A at the generative language model 52. In such examples, the generative language model 52 may be executed with a prompt that includes the application interface code 48, and that further includes an ontology schema selection prompt fragment 77. The ontology schema selection prompt fragment 77 prompts the generative language model to select an ontology schema 22A that matches the application interface code 48. Accordingly, the one or more processing devices 12 may be configured to use the code modeling capabilities of the generative language model 52 to classify the application interface code 48.

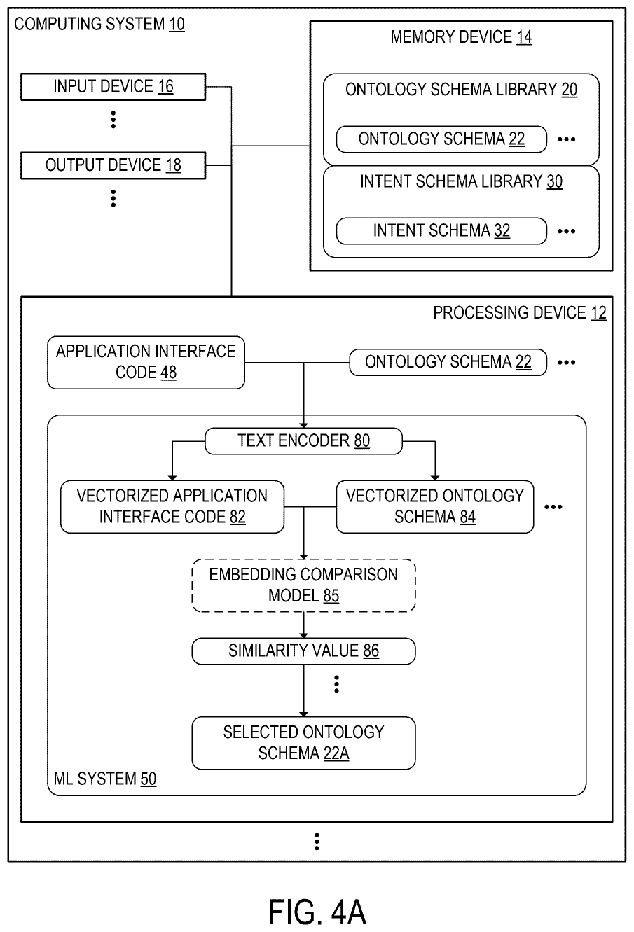

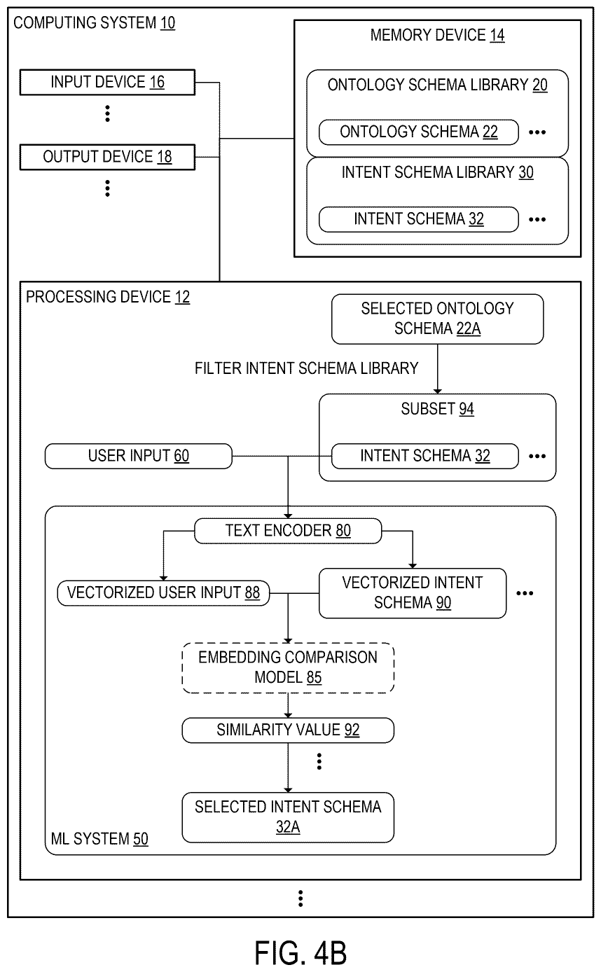

In other examples, the one or more processing devices 12 may instead be configured to select the ontology schema 22A at least in part by performing vector similarity matching between the application interface code 48 and the plurality of ontology schemas 22 included in the ontology schema library 20. FIG. 4A schematically shows the computing system 10 in an example in which vector similarity matching is performed to select the ontology schema 22A. In the example of FIG. 4A, the one or more processing devices 12 are configured to process the application interface code 48 and the ontology schemas 22 at a text encoder 80 included in the ML system 50. The one or more processing devices 12 are thereby configured to compute vectorized application interface code 82 and a plurality of vectorized ontology schemas 84.

The one or more processing devices 12 are further configured to compute a plurality of similarity values 86 between the vectorized application interface code 82 and the vectorized ontology schemas 84 in the embedding space of the text encoder 80. For example, the similarity values 86 may be cosine similarity values. The one or more processing devices 12 may be further configured to select the ontology schema 22A that has the highest similarity value 86. In other examples, the one or more processing devices 12 may be configured to execute an embedding comparison model 85 to compute the similarity values 86. The embedding comparison model 85, in such examples, is an ML model configured to receive the vectorized application interface code 82 and a corresponding vectorized ontology schema 84. The embedding comparison model 85 is further configured to compute the similarity value 86 as a semantic similarity between those input vectors. In some examples, a generative language model may be used as the embedding comparison model 85, whereas in other examples, the embedding similarity model 85 may be a model trained specifically to perform semantic vector matching. Accordingly, the one or more processing devices 12 perform vector similarity matching to identify the ontology schema 22A that most closely matches the application interface code 48.

Returning to FIG. 3, the one or more processing devices 12 are further configured to select an intent schema 32A from among the plurality of intent schemas 32 included in the intent schema library 30 based at least in part on the user input 60 and the selected ontology schema 22A. In some examples, as shown in FIG. 3, the one or more processing devices 12 may be configured to select the intent schema 32A at the generative language model 52. In such examples, the one or more processing devices 12 may be configured to execute the generative language model 52 with a prompt that includes the user input 60, the selected ontology schema 22A, and an intent schema selection prompt fragment 78. The intent schema selection prompt fragment 78 instructs the generative language model 52 to classify the combination of the user input 60 and the selected ontology schema 22A.

FIG. 4B schematically shows the computing system 10 in an example in which the one or more processing devices 12 are configured to select the intent schema 32A at least in part by performing vector similarity matching between the user input 60 and at least a subset 94 of the plurality of intent schemas 32 included in the intent schema library 30. The one or more processing devices 12 may be configured to compute the subset 94 of the plurality of intent schemas 32 by filtering the intent schema library 30 according to which of the intent schemas 32 are associated with the selected ontology schema 22A. The one or more processing devices 12 are further configured to process the user input 60 and the intent schemas 32 included in the subset 94 at the text encoder 80 to thereby obtain a vectorized user input 88 and a plurality of vectorized intent schemas 90. The one or more processing devices 12 are further configured to compute a plurality of similarity values 92 (e.g., cosine similarity values) between the vectorized user input 88 and the vectorized intent schemas 90, and to select the intent schema 32A that has the highest similarity value 92. In some examples, the embedding similarity model 85 may be executed with the vectorized user input 88 and the vectorized intent schemas 90 as inputs to compute the similarity values 92. Thus, the one or more processing devices 12 are configured to identify the intent schema 32A that most closely matches the user input 60 in the embedding space of the text encoder 80.

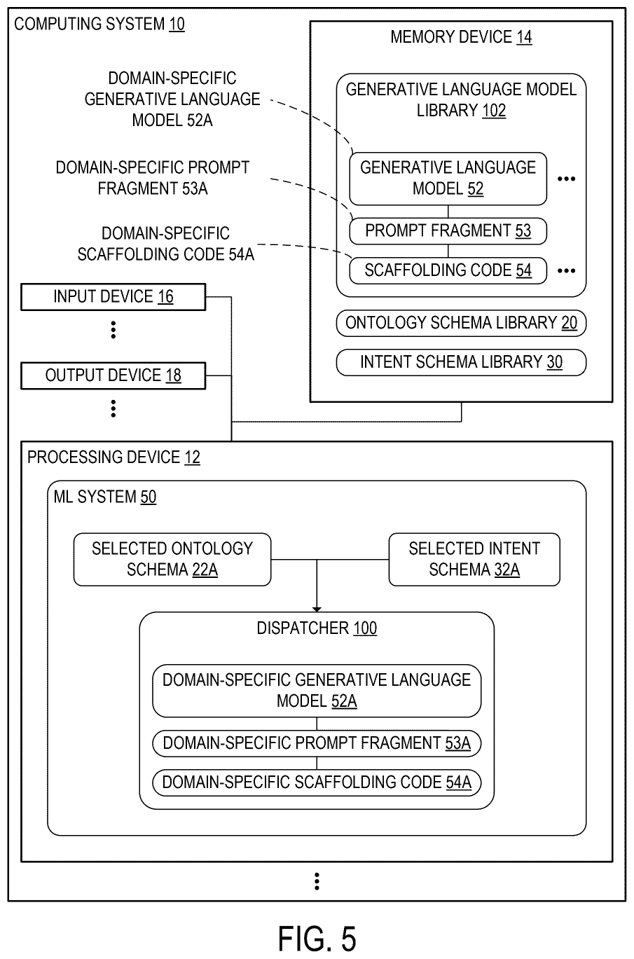

In some examples, as shown in FIG. 5, the one or more processing devices 12 are further configured to execute a dispatcher 100 included in the ML system 50. The dispatcher 100 is a module of the ML system 50 that manages deployment of sub-processes of the ML system 50 that invoke one or more generative language models 52. For example, the prompts of the one or more generative language models 52 may be constructed at least in part at the dispatcher 100. The dispatcher 100 is configured to receive the selected ontology schema 22A and the selected intent schema 32A in the example of FIG. 5.

At the dispatcher 100, the one or more processing devices 12 are further configured to select the generative language model 52 from among a plurality of domain-specific generative language models 52A. The generative language model 52 is selected based at least in part on the selected ontology schema 22A and the selected intent schema 32A. As discussed in further detail below, the selected generative language model 52 may be used to fill the selected ontology schema 22A and/or the selected intent schema 32A. In addition, the one or more processing devices 12 may be configured to execute the selected generative language model 52 to compute the one or more assistant responses 62 that are generated during user interaction with the ML assistant interface 56. In some examples, the one or more processing devices 12 are configured to switch between a plurality of generative language models 52 that are executed at different stages of processing the user input 60, or during different portions of the conversation that occurs at the ML assistant interface 56.

At the dispatcher 100, the one or more processing devices 12 may be further configured to select one or more domain-specific prompt fragments 53A and/or domain-specific scaffolding code 54A. The one or more domain-specific prompt fragments 53A, in such examples, may be inserted into the context window of the domain-specific generative language model 52A. The domain-specific scaffolding code 54A may be executed as a wrapper around the domain-specific generative language model 52A that performs pre-processing, performs post-processing, and/or determines conditions under which the domain-specific generative language model 52A is executed.

In the example of FIG. 5, the one or more memory devices 14 store a generative language model library 102 that includes the plurality of domain-specific generative language models 52A. The generative language model library 102 further includes the domain-specific prompt fragments 53A and the domain-specific scaffolding code 54A.

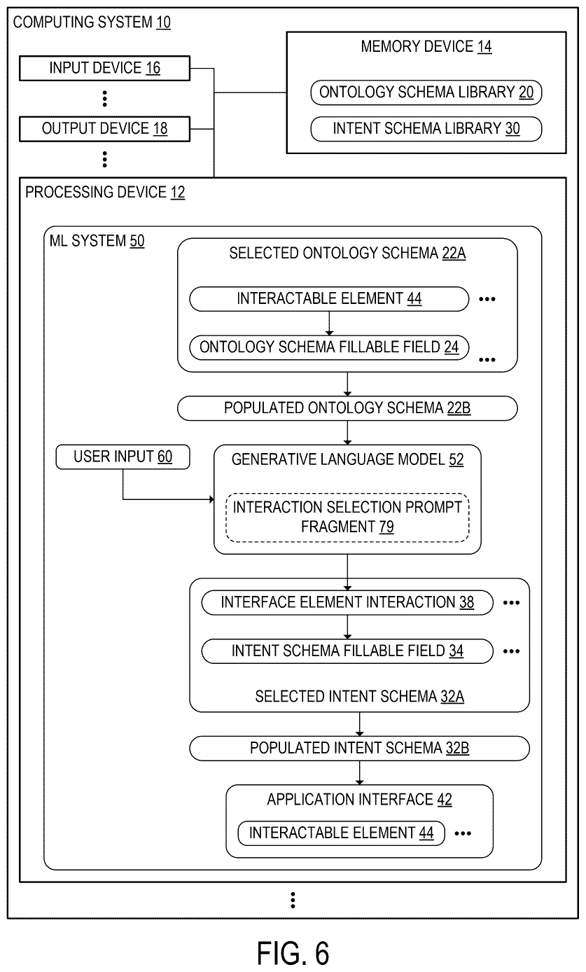

FIG. 6 schematically shows the computing system 10 subsequently to the selection of the ontology schema 22A and the intent schema 32A. At the ML system 50, the one or more processing devices 12 are further configured to populate the selected ontology schema 22A with the plurality of interactable elements 44 of the application interface 42 identified in the application interface code 48. For example, the one or more processing devices 12 are configured to populate the selected ontology schema 22A at least in part by selecting the plurality of interactable elements 44 from among the plurality of predefined interactable elements 26 stored in the ontology schema library 20. The one or more processing devices 12 are further configured to insert these interactable elements 44 into the selected ontology schema 22A as respective filled values of the ontology schema fillable fields 24 included in the selected ontology schema 22A.

The one or more processing devices 12 are further configured to populate the selected intent schema 32A with one or more interface element interactions 38. The one or more processing devices 12 are configured to select these interface element interactions 38 based at least in part on the populated ontology schema 22B and the user input 60. For example, the one or more processing devices 12 may be configured to populate the selected intent schema 32A at least in part by selecting the one or more interface element interactions 38 from among the plurality of predefined interface element interactions 36 included in the intent schema library 30. In such examples, the one or more predefined interface element interactions 36 may be inserted into the selected intent schema 32A as respective filled values of the one or more intent schema fillable fields 34.

In the example of FIG. 6, the one or more processing devices 12 are configured to select the one or more interface element interactions 38 at least in part by processing the populated ontology schema 22B and the user input 60 at the generative language model 52. In such examples, the prompt of the generative language model 52 may further include an interaction selection prompt fragment 79 that instructs the generative language model 52 to select the one or more interface element interactions 38. For example, the prompt of the generative language model 52 may include the user input 60, the populated ontology schema 22B, the plurality of predefined interface element interactions 36 associated with the intent schema 32, and the interaction selection prompt fragment 79. In other examples, the one or more processing devices 12 may instead be configured to select the one or more interface element interactions 38 according to some other approach, such as vector similarity matching.

The one or more processing devices 12 are further configured to programmatically perform the one or more interface element interactions 38 specified by the populated intent schema 32B at the application interface 42. The one or more interface element interactions 38 are performed at an interactable element 44 of the plurality of interactable elements 44 specified in the populated ontology schema 22B. In examples in which the populated intent schema 32B includes a plurality of interface element interactions 38, the interface element interactions 38 may be performed at the same interactable element 44 or at different interactable elements 44.

In the example of FIG. 2, when the user input 60 specifies “Report the weather as cloudy,” the one or more processing devices 12 are configured to select a “report weather” intent schema 32 associated with the weather application. At the generative language model 52, the one or more processing devices 12 are further configured to compute an interface element interaction 38 that, when executed, causes the one or more processing devices 12 to interact with the “report weather” interactable element of the application interface 42 to report the weather as cloudy. The interface element interaction 38 may, for example, be computed as a JavaScript Object Notation (JSON) output and may be processed at an application-programming interface (API) of the weather application. As other examples, the interface element interaction 38 may be a hypertext markup language (HTML) or extensible markup language (XML) output. Thus, the user input 60 is converted into a specific interaction with the application interface 42 that is programmatically executed by the ML system 50.

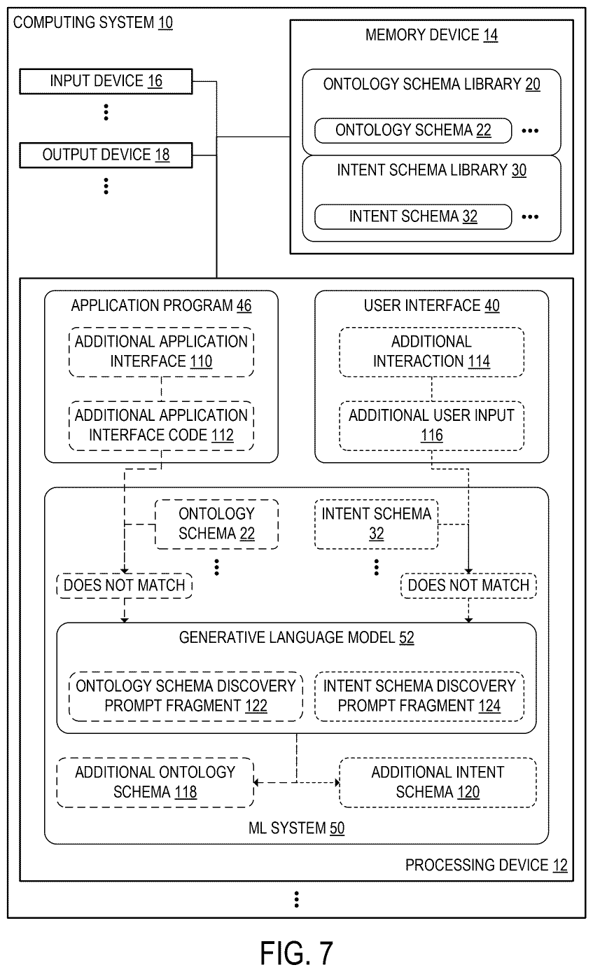

FIG. 7 schematically shows the computing system 10 in an example in which the one or more processing devices 12 are configured to programmatically perform ontology schema discovery and intent schema discovery to add an additional ontology schema 118 and an additional intent schema 120 to the ontology schema library 20 and the intent schema library 30, respectively. In the example of FIG. 7, the one or more processing devices 12 are further configured to receive additional application interface code 112 of an additional application interface 110. For example, the additional application interface 110 may be the interface of an application program or website not previously accessed by the computing system 10. Alternatively, the additional application interface 110 may be an updated version of a previously accessed application interface 42.

The one or more processing devices 12 are further configured to determine that the additional application interface code 112 does not match the ontology schemas 22 stored in the ontology schema library 20. For example, the one or more processing devices 12 may make this determination by performing vector similarity matching between the additional application interface code 112 and the plurality of ontology schemas 22 and determining that the additional application interface code 112 has similarity below a predefined similarity threshold to each of the ontology schemas 22. In other examples, the one or more processing devices 12 may be configured to execute the generative language model 52 to select an ontology schema 22, and the generative language model 52 may output an indication that none of the ontology schemas 22 match the additional application interface code 112.

In response to determining that the additional application interface code 112 does not match the ontology schemas 22, the one or more processing devices 12 are further configured to compute an additional ontology schema 118 at the generative language model 52 based at least in part on additional application interface code 112. The one or more processing devices 12 may be configured to execute the generative language model 52 with a prompt that includes the additional application interface code 112 and an ontology schema discovery prompt fragment 122. Subsequently to computing the additional ontology schema 118, the one or more processing devices 12 are further configured to store the additional ontology schema 118 in the ontology schema library 20. Thus, the one or more processing devices 12 are configured to programmatically expand the set of ontology schemas 22 available during later use of the ML system 50.

In the example of FIG. 7, the one or more processing devices 12 are further configured to receive an additional user input 116 that specifies an additional interaction 114 with the application interface 42. The one or more processing devices 12 are further configured to determine that the additional user input 116 does not match the intent schemas 32 stored in the intent schema library 30. The one or more processing devices 12 may be configured to make this determination at the generative language model 52 or by performing vector similarity matching between the additional user input 116 and the intent schemas 32.

In response to determining that the additional user input 116 does not match the intent schemas 32, the one or more processing devices 12 are further configured to compute an additional intent schema 120 at the generative language model 52 based at least in part on the additional user input 116. The one or more processing devices 12 may be configured to execute the generative language model 52 with a prompt that includes the additional user input 116 and an intent schema discovery prompt fragment 124 in order to compute the additional intent schema 120. The one or more processing devices 12 are further configured to store the additional intent schema 120 in the intent schema library 30. The one or more processing devices 12 are accordingly configured to extend the intent schema library 30 to handle additional types of intents.

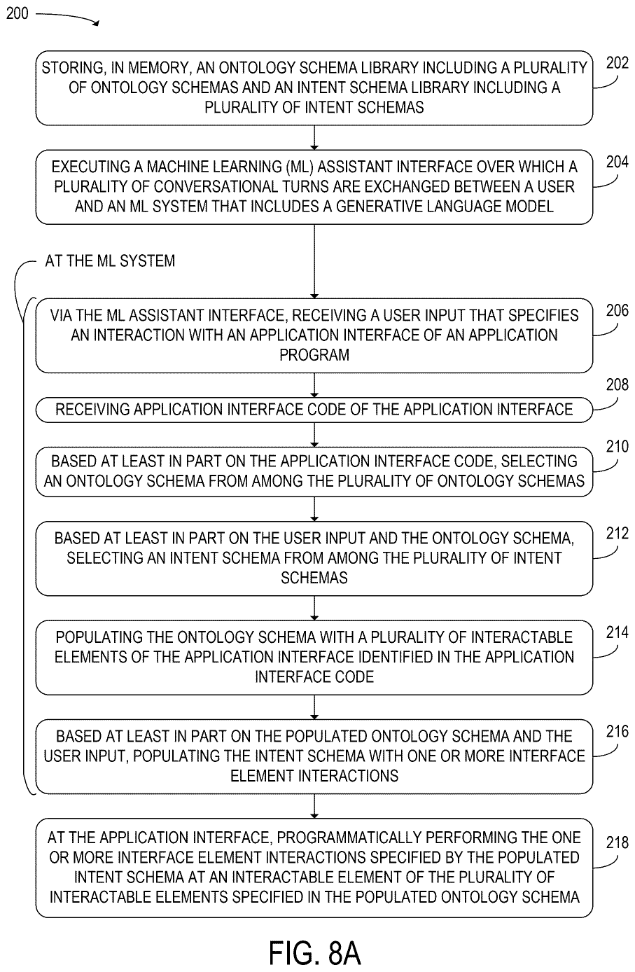

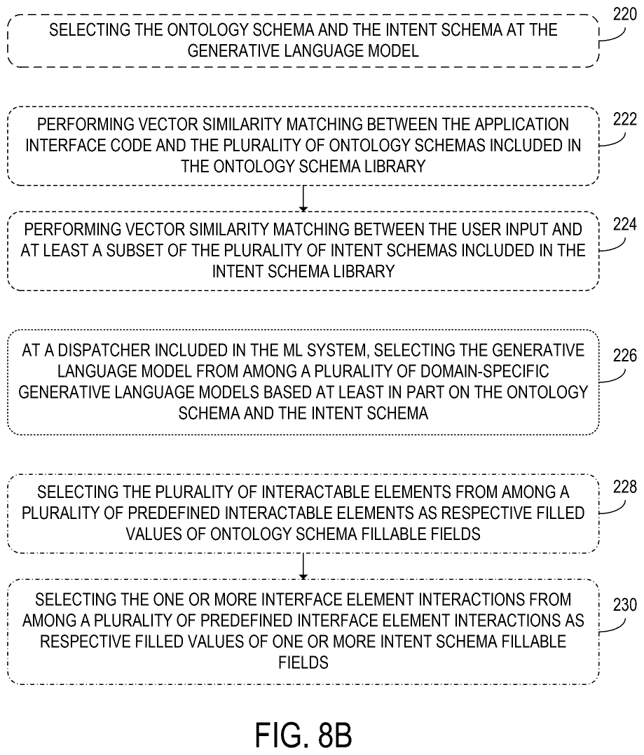

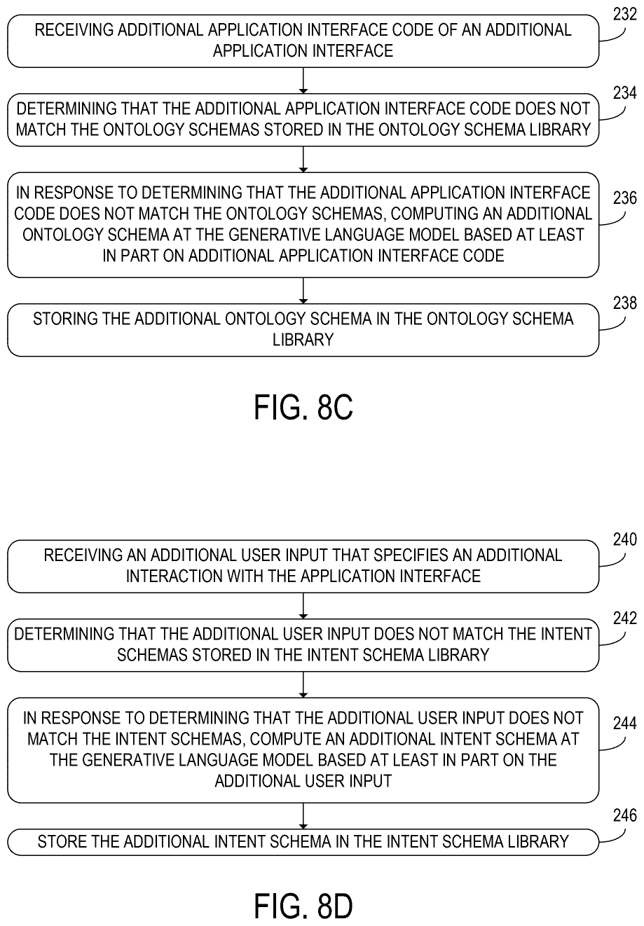

FIG. 8A shows a flowchart of a method 200 for use with a computing system to programmatically interact with an application interface as indicated by user input to an ML system. At step 202, the method 200 includes storing, in memory, an ontology schema library including a plurality of ontology schemas and an intent schema library including a plurality of intent schemas. Each ontology schema is a structured template of a corresponding type of application interface. Each intent schema is a structured template of a corresponding type of user-specified interaction with an application interface. In some examples, each of the ontology schemas may include a plurality of ontology schema fillable fields. In such examples, the ontology schema library may further include a plurality of predefined interactable elements as respective eligible values of the ontology schema fillable fields. Similarly, in some examples, each of the intent schemas may include one or more intent schema fillable fields. In such examples, the intent schema library may further include a plurality of predefined interface element interactions associated with the intent schemas as eligible values of the intent schema fillable fields.

At step 204, the method 200 further includes executing an ML assistant interface over which a plurality of conversational turns are exchanged between a user and an ML system. The ML system includes a generative language model, which may be an LLM, and SLM, or an LMM. The ML assistant interface is presented to the user at a user interface, such as a GUI or an audio interface.

Steps 206, 208, 210, 212, 214, and 216 are performed at the ML system with which the user exchanges the conversational turns. At step 206, the method 200 further includes receiving a user input via the ML assistant interface. The user input specifies an interaction with an application interface of an application program. The user input may be a natural language input. In some examples, the application interface may be a webpage presented to the user at a browser. Alternatively, the application interface may be an interface of a standalone application program.

At step 208, the method 200 further includes receiving application interface code of the application interface. The application interface code may, for example, be code that defines a webpage presented at a browser. The application interface code may alternatively be code that defines the user interface of some other type of application program.

At step 210, the method 200 further includes selecting an ontology schema from among the plurality of ontology schemas based at least in part on the application interface code. The selected ontology schema is the ontology schema that, as determined at the ML system, matches the application interface the application interface code defines. The ontology schema is selected from among the plurality of ontology schemas stored in the ontology schema library.

At step 212, the method 200 further includes selecting an intent schema from among the plurality of intent schemas based at least in part on the user input and the ontology schema. The selected intent schema is the intent schema that, as determined by the ML system, matches the type of interaction specified by the user input, as performed at the type of application interface specified by the ontology schema. The intent schema is selected from among the plurality of intent schemas stored in the intent schema library.

At step 214, the method 200 further includes populating the ontology schema with a plurality of interactable elements of the application interface identified in the application interface code. The interactable elements may be identified within the application interface code using the code modeling capabilities of the generative language model. At step 216, the method 200 further includes populating the intent schema with one or more interface element interactions based at least in part on the populated ontology schema and the user input. In some examples, the one or more interface element interactions are also computed at the generative language model.

At step 218, the method 200 further includes programmatically performing the one or more interface element interactions specified by the populated intent schema at the application interface. The one or more interface element interactions are performed at an interactable element of the plurality of interactable elements specified in the populated ontology schema. Thus, the ML system programmatically performs the interaction specified by the user input.

FIGS. 8B-8D show additional steps of the method 200 that may be performed in some examples. FIG. 8B shows steps that may be performed in some examples to prepare the populated ontology schema and the populated intent schema. At step 220, the method 200 may further include selecting the ontology schema and the intent schema at the generative language model. In such examples, the code modeling and natural language modeling capabilities of the generative language model are used to select the ontology schema that matches the application interface code and the intent schema that matches the user input. In some examples, the generative language model is used to select the ontology schema or the intent schema, but a different technique is used to select the other schema.

In some examples, the method 200 may further include performing step 222 as an alternative to selecting the ontology schema at the generative language model. At step 222, the method 200 further includes performing vector similarity matching between the application interface code and the plurality of ontology schemas included in the ontology schema library. The ontology schema that most closely matches the application interface code may accordingly be selected based on the similarity of vectorized application interface code to vectorized ontology schemas in an embedding space of a text encoder. For example, cosine similarity may be used to perform the vector similarity matching. Alternatively, the vector similarity matching may be performed at least in part by executing an embedding similarity model that computes semantic similarity values between pairs of embedding vectors.

In some examples, the method 200 may further include performing step 224 as an alternative to selecting the intent schema at the generative language model. At step 224, the method 200 further includes performing vector similarity matching between the user input and at least a subset of the plurality of intent schemas included in the intent schema library. The subset of the plurality of intent schemas may be a subset associated with the selected ontology schema. The intent schemas included in that subset may specify eligible types of interface element interactions at the type of application interface specified by the selected ontology schema. The vector similarity matching may, for example, be performed by computing cosine similarity values, or by computing semantic similarity values at the embedding similarity model.

At step 226, the method 200 may further include selecting the generative language model from among a plurality of domain-specific generative language models at a dispatcher included in the ML system. The generative language model is selected based at least in part on the ontology schema and the intent schema. Subsequently to selecting the generative language model, the selected generative language model may be executed to populate the ontology schema and the intent schema as discussed above. The selected generative language model may also be used to generate assistant responses at the ML assistant interface. In some examples, the dispatcher may select a plurality of different generative language models with which different respective subsets of the plurality of interactable elements and the one or more interface element interactions are selected. In addition, the dispatcher may select one or more domain-specific prompt fragments and/or domain-specific scaffolding code with which the one or more domain-specific generative language models are executed.

Step 228 may be performed in examples in which each of the ontology schemas includes a plurality of ontology schema fillable fields. At step 228, populating the ontology schema at step 214 may further include selecting the plurality of interactable elements from among a plurality of predefined interactable elements as respective filled values of the ontology schema fillable fields. For example, the interactable elements may be selected using the generative language model or via vector similarity matching. In some examples, the populated ontology schema includes one or more of the predefined interactable elements along with one or more other interactable elements, such as one or more interactable elements generated at the generative language model.

Step 230 may be performed in examples in which each of the intent schemas includes one or more intent schema fillable fields. At step 230, populating the intent schema at step 216 may further include selecting the one or more interface element interactions from among a plurality of predefined interface element interactions as respective filled values of the one or more intent schema fillable fields. The one or more interface element interactions may be selected using the generative language model or via vector similarity matching. In some examples, the populated intent schema includes one or more of the predefined interface element interactions along with one or more other interface element interactions, such as one or more interface element interactions generated at the generative language model.

FIG. 8C shows additional steps of the method 200 that may be performed in some examples to programmatically perform ontology schema discovery. At step 232, the method 200 may further include receiving additional application interface code of an additional application interface. At step 234, the method 200 may further include determining that the additional application interface code does not match the ontology schemas stored in the ontology schema library. For example, this determination may be made using the generative language model or by performing vector similarity matching between the additional application interface code and the ontology schemas.

At step 236, in response to determining that the additional application interface code does not match the ontology schemas, the method 200 may further include computing an additional ontology schema at the generative language model based at least in part on additional application interface code. At step 238, the method 200 may further include storing the additional ontology schema in the ontology schema library. Accordingly, the ML system may extend the ontology schema library with an additional ontology schema computed from additional application interface code that does not match the already-stored ontology schemas.

FIG. 8D shows additional steps of the method 200 that may be performed in some examples to programmatically perform intent schema discovery. At step 240, the method 200 may further include receiving an additional user input that specifies an additional interaction with the application interface. At step 242, the method 200 may further include determining that the additional user input does not match the intent schemas stored in the intent schema library. For example, this determination may be made using the generative language model or by performing vector similarity matching between the additional user input and the intent schemas.

At step 244, the method 200 may further include computing an additional intent schema at the generative language model based at least in part on the additional user input in response to determining that the additional user input does not match the intent schemas. At step 246, the method 200 may further include storing the additional intent schema in the intent schema library. Accordingly, the ML system may extend the intent schema library with an additional intent schema computed from an additional user input that does not match the already-stored intent schemas.

Using the systems and methods discussed above, the user of an ML system instructs that ML system to programmatically perform semantically specified actions at an application interface presented via a user interface. In order to perform these actions consistently, the ML system maps the user input and the code that defines the application interface onto schemas that provide templates for the contents of the application interface and the intent of the user input. By encoding the application interface ontology and user intent in schemas that follow consistent structural patterns, the interface element interactions computed at the ML system are computed in a reliable manner. In addition, the ontology schema library and the intent schema library may be extended via programmatic schema discovery, thereby allowing the ML system to obtain sets of schemas that match a wider variety of types of application interfaces and user inputs.

The methods and processes described herein are tied to a computing system of one or more computing devices. In particular, such methods and processes can be implemented as a computer-application program or service, an application-programming interface (API), a library, and/or other computer-program product.

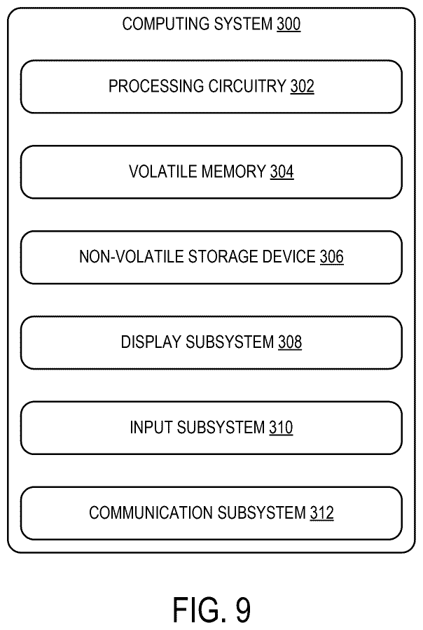

FIG. 9 schematically shows a non-limiting embodiment of a computing system 300 that can enact one or more of the methods and processes described above. Computing system 300 is shown in simplified form. Computing system 300 may instantiate the computing system 10 discussed above with reference to FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 9.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem 312 may allow computing system 300 to send and/or receive messages to and/or from other devices via a network such as the Internet.

The following paragraphs discuss several aspects of the present disclosure. According to one aspect of the present disclosure, a computing system is provided, including one or more processing devices configured to execute a machine learning (ML) assistant interface over which a plurality of conversational turns are exchanged between a user and an ML system that includes a generative language model. At the ML system, via the ML assistant interface, the one or more processing devices are further configured to receive a user input that specifies an interaction with an application interface of an application program. The one or more processing devices are further configured to receive application interface code of the application interface. Based at least in part on the application interface code, the one or more processing devices are further configured to select an ontology schema from among a plurality of ontology schemas. Based at least in part on the user input and the ontology schema, the one or more processing devices are further configured to select an intent schema from among a plurality of intent schemas. The one or more processing devices are further configured to populate the ontology schema with a plurality of interactable elements of the application interface identified in the application interface code. Based at least in part on the populated ontology schema and the user input, the one or more processing devices are further configured to populate the intent schema with one or more interface element interactions. At the application interface, the one or more processing devices are further configured to programmatically perform the one or more interface element interactions specified by the populated intent schema at an interactable element of the plurality of interactable elements specified in the populated ontology schema. The above features may have the technical effect of guiding the ML system to consistently perform a specified type of interaction with a specified type of application interface, even across different semantic specifications of the interaction and/or different application interface configurations.

According to this aspect, the computing system may further include memory storing an ontology schema library including a plurality of ontology schemas and an intent schema library including a plurality of intent schemas. The one or more processing devices may be further configured to select the ontology schema from among the plurality of ontology schemas stored in the ontology schema library and select the intent schema from among the plurality of intent schemas stored in the intent schema library. The above features may have the technical effect of storing predetermined sets of schemas that are matched to the user input and the application interface code in order to achieve consistency across different user inputs and application interfaces.

According to this aspect, the one or more processing devices may be configured to select the ontology schema at least in part by performing vector similarity matching between the application interface code and the plurality of ontology schemas included in the ontology schema library. The above features may have the technical effect of selecting an ontology schema that matches the application interface code.

According to this aspect, the one or more processing devices may be configured to select the intent schema at least in part by performing vector similarity matching between the user input and at least a subset of the plurality of intent schemas included in the intent schema library. The above features may have the technical effect of selecting an intent schema that matches the user input.

According to this aspect, the one or more processing devices may be further configured to receive additional application interface code of an additional application interface. The one or more processing devices may be further configured to determine that the additional application interface code does not match the ontology schemas stored in the ontology schema library. In response to determining that the additional application interface code does not match the ontology schemas, the one or more processing devices may be further configured to compute an additional ontology schema at the generative language model based at least in part on additional application interface code. The one or more processing devices may be further configured to store the additional ontology schema in the ontology schema library. The above features may have the technical effect of performing programmatic schema discovery to add an ontology schema to the ontology schema library.

According to this aspect, the one or more processing devices may be further configured to receive an additional user input that specifies an additional interaction with the application interface. The one or more processing devices may be further configured to determine that the additional user input does not match the intent schemas stored in the intent schema library. In response to determining that the additional user input does not match the intent schemas, the one or more processing devices may be further configured to compute an additional intent schema at the generative language model based at least in part on the additional user input. The one or more processing devices may be further configured to store the additional intent schema in the intent schema library. The above features may have the technical effect of performing programmatic schema discovery to add an intent schema to the intent schema library.

According to this aspect, at a dispatcher included in the ML system, the one or more processing devices may be further configured to select the generative language model from among a plurality of domain-specific generative language models based at least in part on the ontology schema and the intent schema. The above features may have the technical effect of utilizing a generative language model that is specialized in a domain associated with the ontology schema and the intent schema.

According to this aspect, the one or more processing devices may be configured to identify the plurality of interactable elements and the one or more interface element interactions at the generative language model. The above features may have the technical effect of utilizing the code modeling capabilities of the generative language model to programmatically identify the interactable elements and the one or more interface element interactions.

According to this aspect, the one or more processing devices may be configured to select the ontology schema and the intent schema at the generative language model. The above features may have the technical effect of utilizing the natural language modeling and code modeling capabilities of the generative language model to programmatically match the user input and the application interface code to the schemas.

According to this aspect, each of the ontology schemas may include a plurality of ontology schema fillable fields. The one or more processing devices may be configured to populate the ontology schema at least in part by selecting the plurality of interactable elements from among a plurality of predefined interactable elements as respective filled values of the ontology schema fillable fields. The above features may have the technical effect of populating the ontology schema with the interactable elements according to a predefined template structure.

According to this aspect, each of the intent schemas may include one or more intent schema fillable fields. The one or more processing devices may be configured to populate the intent schema at least in part by selecting the one or more interface element interactions from among a plurality of predefined interface element interactions as respective filled values of the one or more intent schema fillable fields. The above features may have the technical effect of populating the intent schema with the one or more interface element interactions according to a predefined template structure.

According to this aspect, the user input may be a natural language input. The above feature may have the technical effect of allowing the user to guide the ML system using natural language.

According to this aspect, the application interface is a webpage presented to the user at a browser. The above feature may have the technical effect of using the ML system to programmatically interact with the webpage.

According to another aspect of the present disclosure, a method for use with a computing system is provided. The method includes executing a machine learning (ML) assistant interface over which a plurality of conversational turns are exchanged between a user and an ML system that includes a generative language model. At the ML system, via the ML assistant interface, the method further includes receiving a user input that specifies an interaction with an application interface of an application program. The method further includes receiving application interface code of the application interface. Based at least in part on the application interface code, the method further includes selecting an ontology schema from among a plurality of ontology schemas. Based at least in part on the user input and the ontology schema, the method further includes selecting an intent schema from among a plurality of intent schemas. The method further includes populating the ontology schema with a plurality of interactable elements of the application interface identified in the application interface code. based at least in part on the populated ontology schema and the user input, populating the intent schema with one or more interface element interactions. At the application interface, the method further includes programmatically performing the one or more interface element interactions specified by the populated intent schema at an interactable element of the plurality of interactable elements specified in the populated ontology schema. The above features may have the technical effect of guiding the ML system to consistently perform a specified type of interaction with a specified type of application interface, even across different semantic specifications of the interaction and/or different application interface configurations.

According to this aspect, the method may further include storing, in memory, an ontology schema library including a plurality of ontology schemas and an intent schema library including a plurality of intent schemas. The ontology schema may be selected from among the plurality of ontology schemas stored in the ontology schema library. The intent schema may be selected from among the plurality of intent schemas stored in the intent schema library. The above features may have the technical effect of storing predetermined sets of schemas that are matched to the user input and the application interface code in order to achieve consistency across different user inputs and application interfaces.

According to this aspect, selecting the ontology schema may include performing vector similarity matching between the application interface code and the plurality of ontology schemas included in the ontology schema library. The above features may have the technical effect of selecting an ontology schema that matches the application interface code.

According to this aspect, selecting the intent schema may include performing vector similarity matching between the user input and at least a subset of the plurality of intent schemas included in the intent schema library. The above features may have the technical effect of selecting an intent schema that matches the user input.

According to this aspect, at a dispatcher included in the ML system, the method may further include selecting the generative language model from among a plurality of domain-specific generative language models based at least in part on the ontology schema and the intent schema. The above features may have the technical effect of utilizing a generative language model that is specialized in a domain associated with the ontology schema and the intent schema.

According to this aspect, selecting the ontology schema and the intent schema at the generative language model. The above features may have the technical effect of utilizing the natural language modeling and code modeling capabilities of the generative language model to programmatically match the user input and the application interface code to the schemas.

According to another aspect of the present disclosure, a computing system is provided, including one or more processing devices configured to, at a machine learning (ML) system, receive a user input that specifies an interaction with an application interface of an application program. The one or more processing devices may be further configured to receive application interface code of the application interface. At least in part by executing a generative language model included in the ML system, the one or more processing devices may be further configured to, based at least in part on the application interface code, select an ontology schema from among a plurality of ontology schemas. Based at least in part on the user input and the ontology schema, the one or more processing devices may be further configured to select an intent schema from among a plurality of intent schemas at least in part by executing the generative language model. At least in part by executing the generative language model, the one or more processing devices may be further configured to populate the ontology schema with a plurality of interactable elements of the application interface identified in the application interface code. Based at least in part on the populated ontology schema and the user input, at least in part by executing the generative language model, the one or more processing devices may be further configured to populate the intent schema with one or more interface element interactions. At the application interface, the one or more processing devices may be further configured to programmatically perform the one or more interface element interactions specified by the populated intent schema at an interactable element of the plurality of interactable elements specified in the populated ontology schema. The above features may have the technical effect of guiding the ML system to consistently perform a specified type of interaction with a specified type of application interface, even across different semantic specifications of the interaction and/or different application interface configurations.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
execute a machine learning (ML) assistant interface over which a plurality of conversational turns are exchanged between a user and an ML system that includes a generative language model;
at the ML system:
via the ML assistant interface, receive a user input that specifies an interaction with an application interface of an application program;
receive application interface code of the application interface;
based at least in part on the application interface code, select an ontology schema from among a plurality of ontology schemas;
based at least in part on the user input and the ontology schema, select an intent schema from among a plurality of intent schemas;
populate the ontology schema with a plurality of interactable elements of the application interface identified in the application interface code; and
based at least in part on the populated ontology schema and the user input, populate the intent schema with one or more interface element interactions; and
at the application interface, programmatically perform the one or more interface element interactions specified by the populated intent schema at an interactable element of the plurality of interactable elements specified in the populated ontology schema.

2. The computing system of claim 1, further comprising memory storing:
an ontology schema library including a plurality of ontology schemas; and
an intent schema library including a plurality of intent schemas,
wherein the one or more processing devices are configured to:
select the ontology schema from among the plurality of ontology schemas stored in the ontology schema library; and
select the intent schema from among the plurality of intent schemas stored in the intent schema library.

3. The computing system of claim 2, wherein the one or more processing devices are configured to select the ontology schema at least in part by performing vector similarity matching between the application interface code and the plurality of ontology schemas included in the ontology schema library.

4. The computing system of claim 2, wherein the one or more processing devices are configured to select the intent schema at least in part by performing vector similarity matching between the user input and at least a subset of the plurality of intent schemas included in the intent schema library.

5. The computing system of claim 2, wherein the one or more processing devices are further configured to:
receive additional application interface code of an additional application interface;
determine that the additional application interface code does not match the ontology schemas stored in the ontology schema library;
in response to determining that the additional application interface code does not match the ontology schemas, compute an additional ontology schema at the generative language model based at least in part on additional application interface code; and
store the additional ontology schema in the ontology schema library.

6. The computing system of claim 2, wherein the one or more processing devices are further configured to:
receive an additional user input that specifies an additional interaction with the application interface;
determine that the additional user input does not match the intent schemas stored in the intent schema library;
in response to determining that the additional user input does not match the intent schemas, compute an additional intent schema at the generative language model based at least in part on the additional user input; and
store the additional intent schema in the intent schema library.

7. The computing system of claim 1, wherein, at a dispatcher included in the ML system, the one or more processing devices are further configured to select the generative language model from among a plurality of domain-specific generative language models based at least in part on the ontology schema and the intent schema.

8. The computing system of claim 1, wherein the one or more processing devices are configured to identify the plurality of interactable elements and the one or more interface element interactions at the generative language model.

9. The computing system of claim 1, wherein the one or more processing devices are configured to select the ontology schema and the intent schema at the generative language model.

10. The computing system of claim 1, wherein:
each of the ontology schemas includes a plurality of ontology schema fillable fields;
the one or more processing devices are configured to populate the ontology schema at least in part by selecting the plurality of interactable elements from among a plurality of predefined interactable elements as respective filled values of the ontology schema fillable fields.

11. The computing system of claim 1, wherein:
each of the intent schemas includes one or more intent schema fillable fields; and
the one or more processing devices are configured to populate the intent schema at least in part by selecting the one or more interface element interactions from among a plurality of predefined interface element interactions as respective filled values of the one or more intent schema fillable fields.

12. The computing system of claim 1, wherein the user input is a natural language input.

13. The computing system of claim 1, wherein the application interface is a webpage presented to the user at a browser.

14. A method for use with a computing system, the method comprising:
executing a machine learning (ML) assistant interface over which a plurality of conversational turns are exchanged between a user and an ML system that includes a generative language model;
at the ML system:
via the ML assistant interface, receiving a user input that specifies an interaction with an application interface of an application program;
receiving application interface code of the application interface;
based at least in part on the application interface code, selecting an ontology schema from among a plurality of ontology schemas;
based at least in part on the user input and the ontology schema, selecting an intent schema from among a plurality of intent schemas;
populating the ontology schema with a plurality of interactable elements of the application interface identified in the application interface code; and
based at least in part on the populated ontology schema and the user input, populating the intent schema with one or more interface element interactions; and
at the application interface, programmatically performing the one or more interface element interactions specified by the populated intent schema at an interactable element of the plurality of interactable elements specified in the populated ontology schema.

15. The method of claim 14, further comprising storing, in memory, an ontology schema library including a plurality of ontology schemas and an intent schema library including a plurality of intent schemas, wherein:
the ontology schema is selected from among the plurality of ontology schemas stored in the ontology schema library; and
the intent schema is selected from among the plurality of intent schemas stored in the intent schema library.

16. The method of claim 15, wherein selecting the ontology schema includes performing vector similarity matching between the application interface code and the plurality of ontology schemas included in the ontology schema library.

17. The method of claim 15, wherein selecting the intent schema includes performing vector similarity matching between the user input and at least a subset of the plurality of intent schemas included in the intent schema library.

18. The method of claim 14, further comprising, at a dispatcher included in the ML system, selecting the generative language model from among a plurality of domain-specific generative language models based at least in part on the ontology schema and the intent schema.

19. The method of claim 14, further comprising selecting the ontology schema and the intent schema at the generative language model.

20. A computing system comprising:
one or more processing devices configured to:
at a machine learning (ML) system:
receive a user input that specifies an interaction with an application interface of an application program;
receive application interface code of the application interface;
at least in part by executing a generative language model included in the ML system:
based at least in part on the application interface code, select an ontology schema from among a plurality of ontology schemas;
based at least in part on the user input and the ontology schema, select an intent schema from among a plurality of intent schemas;
populate the ontology schema with a plurality of interactable elements of the application interface identified in the application interface code; and
based at least in part on the populated ontology schema and the user input, populate the intent schema with one or more interface element interactions; and
at the application interface, programmatically perform the one or more interface element interactions specified by the populated intent schema at an interactable element of the plurality of interactable elements specified in the populated ontology schema.
